(19) United States
(12) Patent Application Publication
(10) Pub. No.: US 2004/0100402 A1
(43) Pub. Date: May 27, 2004

(54) Broadband CSC2 antenna pattern beam forming networks

(76) Inventor: Jay McCandless, Bellevue, WA (US)

Correspondence Address: Duane Morris LLP, Suite 700, 1667 K Street, N.W., Washington, DC, 20006, US

(21) Appl. No.: 10/303,953

(22) Filed: Nov. 26, 2002

(51) Int. Cl. H01Q 3/00; H01Q 3/22

(52) U.S. Cl. 342/368; 342/360

(57) ABSTRACT

A method and beam-forming network for generating null-filled antenna patterns that approximate double-sided co-secant-squared antenna patterns is disclosed. The method comprises the steps of coupling an input signal to a plurality of output ports arranged in an array through at least one coupler element wherein an amplitude distribution at the output ports follows substantially a ramp function. In another aspect of the invention, electrical phase of the output signals are phase adjusted such that the output phase values are substantially the same.

### BACKGROUND OF THE INVENTION

The present invention relates to antenna technology and more specifically to methods and beam-forming networks for approximating broadband co-secant squared (CSC²) antenna patterns.

Cosecant-squared (CSC²) antenna patterns were initially developed for radio guidance systems used to detect and control approaching aircraft. CSC² patterns are advantageous as an approaching plane flying at a constant altitude will receive a constant signal strength from the transmitting antenna. CSC² antennas are also useful in cellular communication systems for the same reason. In cellular communications, a plurality of antennas are mounted on towers such that each antenna provides transmission and reception of signals within a designated spatial coverage area. Conventionally, three antennas, each covering a sector of 120 degrees, are sufficient for providing acceptable coverage for users within a five-mile radius of a cellular tower. In this case, each sector antenna, with an appropriate down-tilt to account for the elevated height of the antenna, provides constant signal strength for the users on the ground.

In newer point-to-multipoint systems or local multipoint distributed systems (LMDS), antennas with CSC² patterns are also desirable. However, in such systems the antenna pattern is typically non-symmetrical, i.e., single-sided, as there is little need for signal detection above the height of the antenna. However, single-sided CSC² antenna exhibit undefined antenna characteristics above the horizontal plane and creates unexpected signal detection responses. Thus, double-sided CSC² patterns are more desirable, particularly when the antenna height is on a building or tower that is lower than the customer or user sites.

Both single- and double-sided CSC² pattern sector antennas for cellular systems are conventionally generated by feeding a network of waveguide elements with a waveguide feed at millimeter wave frequencies. Although these networks do not generate a CSC² pattern they do generate a “null-filled” pattern that approximates a desired CSC² pattern. However, these networks are difficult to construct as precise amplitude and phase control of the waveguide outputs is necessary. Thus, the conventional beam-forming networks are limited to a narrow band of frequencies as it is difficult to implement precise amplitude and phase control in each waveguide over a broad range of frequencies.

Hence, there is a need for a method for creating beam-forming networks that produce an approximation of a CSC² antenna pattern that is easy to implement and maintains the desired CSC antenna characteristics over a broad frequency range.

### BRIEF DESCRIPTION OF THE DRAWINGS

In the drawings:

FIGS. 1a and 1b illustrate conventional beam-forming networks;

FIG. 1c illustrates a graph of a desired near-field amplitude/phase characteristics of a far-field double-sided CSC² antenna pattern;

FIG. 2a illustrates a graph of a near-field amplitude pattern for a summing network;

FIG. 2b illustrates a graph of a near-field amplitude pattern for a low-gain difference network;

FIG. 2c illustrates a graph of a combined sum and difference network near-field amplitude pattern;

FIG. 2d illustrates a first exemplary embodiment of a beam-forming network in accordance with the principles of the invention;

FIG. 3a illustrates a second exemplary embodiment of a beam-forming network in accordance with the principles of the invention;

FIG. 3b illustrates a graph of an amplitude distribution pattern for the beam-forming network illustrated in FIG. 3a;

FIG. 3c illustrates a far-field antenna pattern produced using the exemplary embodiment shown in FIG. 3a;

FIG. 4a illustrates a second aspect of the beam-forming network shown in FIG. 3a;

FIG. 4b illustrates a another aspect of the beam-forming network shown in FIG. 3a;

FIG. 5a illustrates a third exemplary embodiment of a beam forming network in accordance with the principles of the invention;

FIG. 5b illustrates a graph of an amplitude distribution pattern for the beam-forming network illustrated in FIG. 5a; and

FIG. 6 illustrates a still another near-field amplitude distribution in accordance with the principles of the invention.

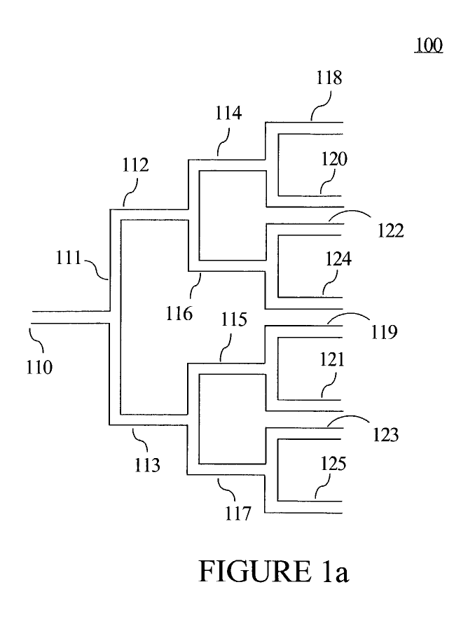

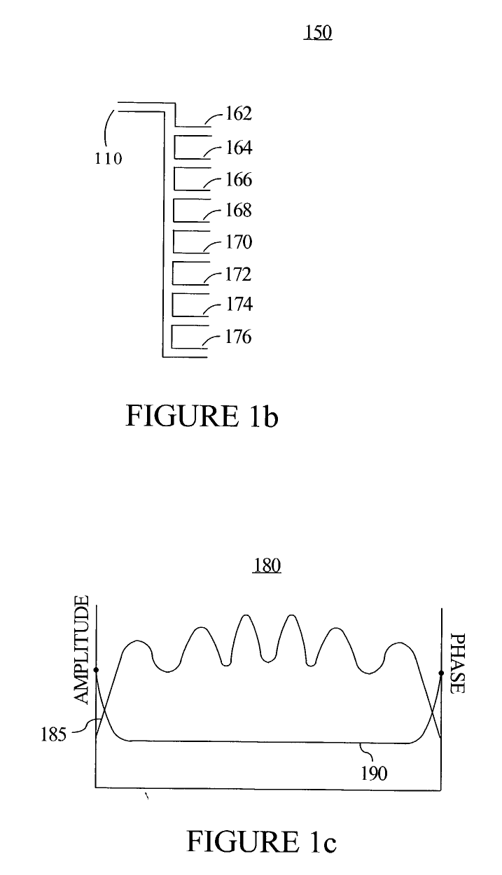

It is to be understood that these drawings are solely for purposes of illustrating the concepts of the invention and are not intended as a definition of the limits of the invention. The embodiments shown in FIGS. 1 through 6 and described in the accompanying detailed description are to be used as illustrative embodiments and should not be construed as the only manner of practicing the invention. It is to be understood that these drawings are for purposes of illustrating the concepts of the invention and are not to scale. Also, the same reference numerals, possibly supplemented with reference characters where appropriate, have been used to identify similar elements.

### DETAILED DESCRIPTION OF THE INVENTION

FIG. 1a illustrates a conventional beam-forming network 100. In this network, a signal applied to input feed 110 is coupled to each of the output ports by dividing the input signal using couplers to route the signal from the input to the outputs. In this illustrative example, a signal applied to input feed 110 is divided using power divider, coupler or splitter, 111, and coupled into branches 112, 113, respectively. The divided signal in each of branches 112, 113 is further divided, using dividers, into branches 114, 116, 115 and 117, respectively. The signal in branches 114, 116, 115 and 117 is next divided by power dividers to form branches 118, 120, 122, 124, 119, 121, 123, and 125. Branches 118, 120, 122, 124, 119, 121, 123, and 125 then provide the signal contained in each branch to a radiating elements, such as horns, waveguides, slots, dipoles, etc., (not shown). In this conventional network, substantially the same amplitude is present at the outputs of branch element 118, 120, 122, 124, 119, 121, 123, and 125.

FIG. 1b illustrates a second conventional beam-forming network 150. In this network, a signal applied to input feed 110 is divided, using a multiple-output divider, into branches 162 through 176. In this second conventional network substantially the same amplitude and phase is present at each output port.

FIG. 1c illustrates a desired conventional near-field amplitude and phase distribution 180 for the conventional beam-forming networks shown in FIGS. 1a and 1b. In this case, each output port has the same amplitude output, represented by graph 185, and substantially the same phase, represented as graph 190. The desired near-field amplitude distribution and phase distribution produces a “null-filled” antenna pattern that approximates a CSC² antenna pattern. As will be understood, mutual coupling of the output amplitudes is not shown in order to illustrate the desired amplitude distribution. In fact, significant effort is required to reduce the mutual coupling that occurs.

To achieve the desired the amplitude and phase distributions the beam-forming networks shown must be finely detailed to provide substantially constant signal loss and similar phase change in each signal path. Hence, as frequency of operation changes, the amplitude and electrical phase distribution must be re-determined and readjusted. Thus, for off-frequency or out-of-band operation, the far field antenna characteristics vary significantly as the near-field amplitude and electrical phase distribution characteristics change. Thus, the antenna patterns formed by conventional networks shown are typically limited frequency of operation.

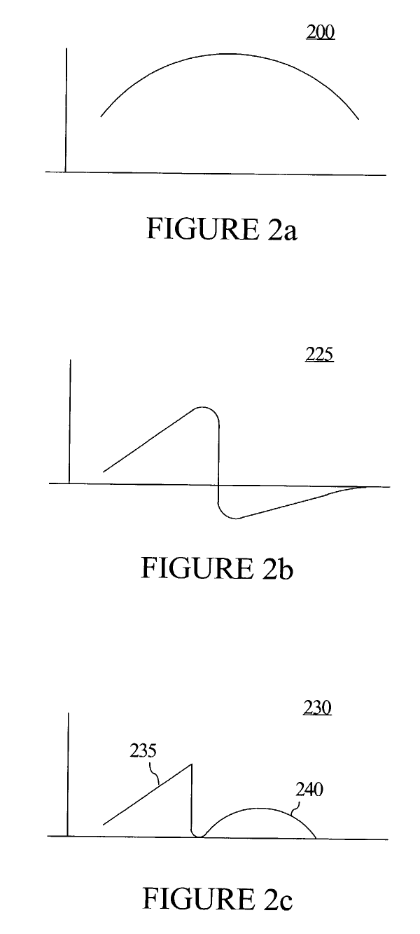

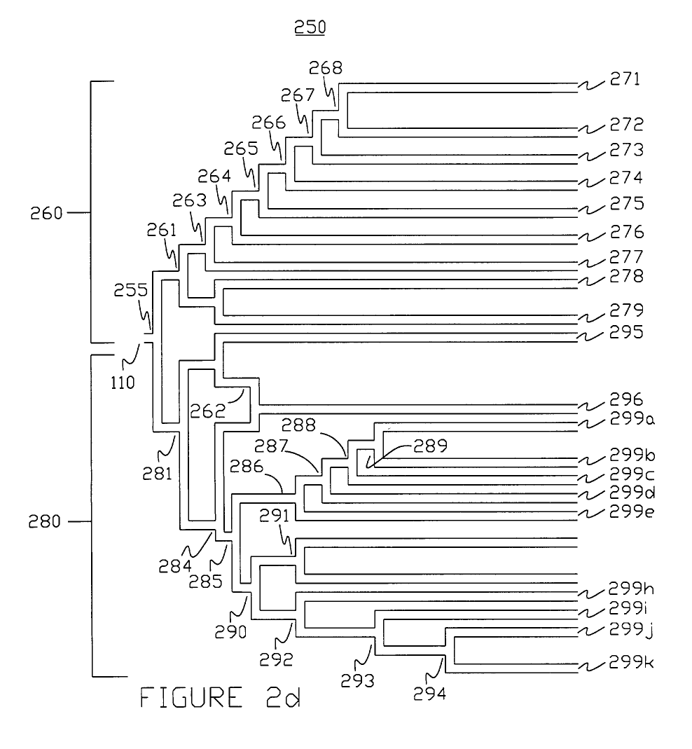

FIG. 2a illustrates the amplitude distribution 200 of a conventional network that sums the outputs of either network shown in FIG. 1a or 1b. In this case, each element of the beam-forming network provides a summing network with a substantially equal amplitude value. In this case, the amplitude distribution of the summing network may be a constant value. The tapered signal 200 shown in FIG. 2a may be obtained by adjusting the signal amplitudes at the ends of the array.

FIG. 2b illustrates the amplitude distribution 225 of a low-gain difference network. The difference network amplitude distribution may be obtained by altering the phase, by 180 degrees, of one-half of the network elements shown in either FIG. 1a or 1c.

FIG. 2c illustrates an amplitude distribution 230 of a network that combines, mathematically, the amplitude distributions shown in FIGS. 2a and 2b. In this case, the amplitude distribution produces a ramp-like amplitude distribution 235 and a smaller distribution 240 in the shape of a bump. As will be understood, the far-field antenna patterns of the combined summing and difference network combine to produce a “null-filled” antenna pattern that approximates a CSC² pattern.

FIG. 2d illustrates a first exemplary embodiment 250 of the invention for producing the near-field amplitude distribution pattern shown in FIG. 2c in accordance with the principles of the invention. In this embodiment, an input signal applied to input port 110 is divided or split by divider 255 such that a known portion is provided to a first network 260 and the remainder is provided to a second network 280. The signal applied to network 260 is subsequently divided using dividers 261-268 such that the amplitude at each port is progressively less. In preferred embodiment, divider 110 and subsequent dividers 261-268 are 3 dB dividers, which divide the signal applied to an input port between two output ports. In this preferred embodiment the output of network 260 is a ramp-like function having one-eighth (⅛^{th}) energy of the signal applied at input port 110 at output ports 279-279. The output then is decreased such that one-sixteenth (1/16^{th}), one-thirty-second (1/32^{nd}), one sixty-fourth (1/64^{th}) and one-one hundred twenty-eight (1/128^{th}) of the energy of the signal applied at input port 110, is present at ports 276, 275, 274 and 273 respectively. And one-two-hundred fifty-sixth (1/256^{th}) of the energy of the signal applied at input port 110 is present at output ports 271 and 272.

With regard to second network 280, the applied signal is divided using dividers 281-294, such that the amplitude distribution has one portion that exhibits a ramp-like function and one portion that is substantially symmetrical. In a preferred embodiment, dividers 281-294 are 3 dB dividers or splitters. In this preferred embodiment, the signal present at ports 295 and 296 is one-eight (⅛^{th}) and one-quarter (¼^{th}), respectively, the signal energy applied at input port 110. As will be understood, divider 283 is used as a combiner wherein the signals applied to two output ports are combined as a single output, which is applied to port 296.

With regard to signal applied to divider 284, this signal is divided such that the amplitude distribution at the remaining ports, represented as 299a-299k is substantially symmetrical. For example, using 3 dB splitters for dividers 284-294, the amplitude distribution of this portion of network 280 is such that of the signal energy applied to port 110, one-thirty-second is present at port 299e, one sixth-fourth (1/64^{th}) is present at ports 299d, 299f-299h, one one-hundred twenty eight (1/128^{th}) is present at ports 299c, 299i and one-two hundred fifty-sixth (1/256^{th}) is present ports 299a, 299b, 299j, and 299k. As will be understood, the length of each of the branches shown is substantially the same in order to provide similar signal loss in each branch

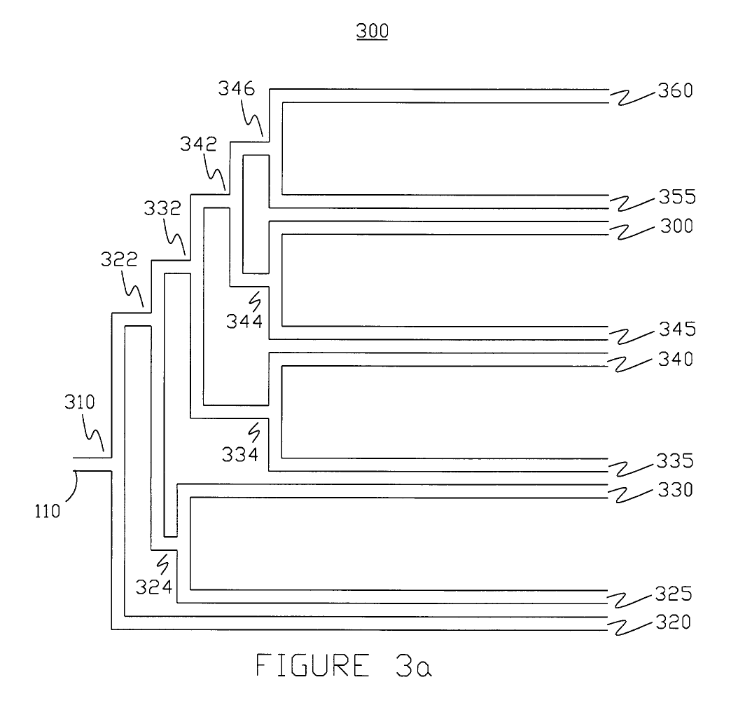

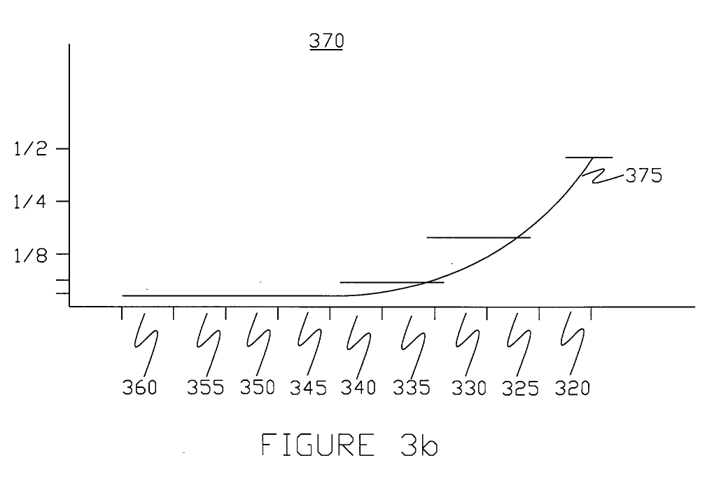

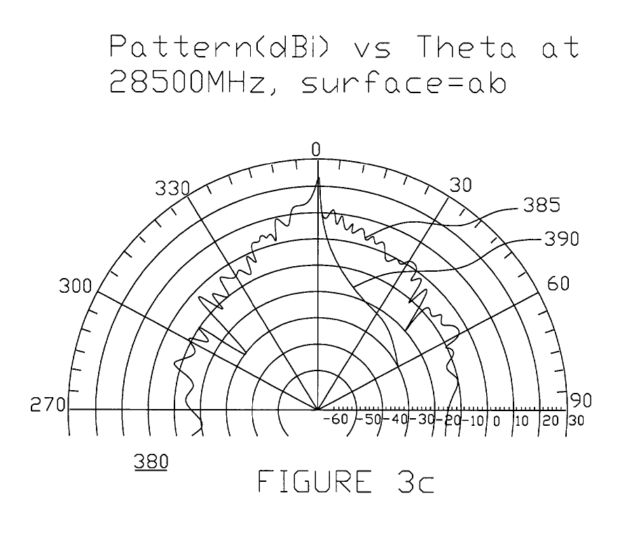

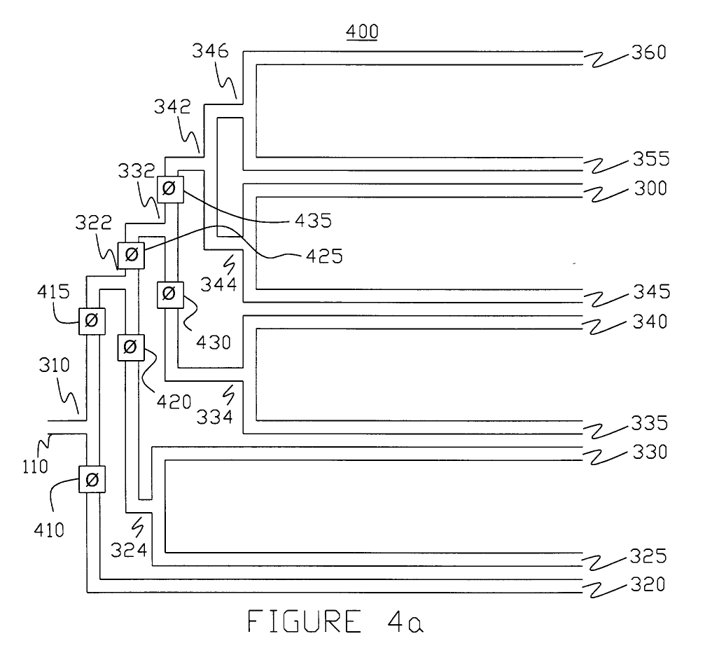

FIG. 3a illustrates an embodiment of a nine-element beam-forming network in accordance with the principles of the present invention that produces a near-field ramp-like amplitude function that approximates the amplitude distribution shown in FIG. 2c. In this embodiment of the invention, a signal applied to input waveguide feed 110 is selected divided, using power dividers, couplers or splitters, to provide a known signal power at each output port. In this case, a signal applied to input port 110 is divided, by divider 310, such that a known portion of the input signal energy is applied directly to output 320 and the remaining portion is applied to divider 322. The signal energy applied to divider 332 is further divided such that a known portion of the signal energy is applied to divider 324 and the remaining portion is applied to divider 332. The signal energy applied to divider 324 is then divided and applied to outputs 325 and 330. The signal energy applied to divider 332 is further divided such that a known portion of the signal energy is applied to divider 334 and the remaining energy is applied to divider 342. The signal energy applied to divider 334 is further divided such that a known portion is applied to output port 335 and the remaining applied to output port 340. Similarly, the energy applied to divider 342 is further divided such that a known portion is applied to divider 344 and the remaining energy applied to divider 346. The signal energy applied to divider 344 is further divided such that a known portion of the energy is applied to output port 345 and the remaining energy is applied to output port 350. This signal energy applied to divider 346 is divided such that a known portion of the signal energy is applied to output port 355 and the remaining energy is applied to output port 360.

Hence, in one aspect of the invention, progressively less of the applied signal energy is applied to each output port. Accordingly, dividers 310, 322, 332, 324, 332, 334, 344 and 336 may be individually adjusted such at any combination of signal energies may be the output from a corresponding port.

In a preferred embodiment of the invention, dividers 310, 322, 324, 332, 334, 342, 344, and 346 are elements that divide the input signal energy or power substantially in half. For example, divider elements may be 3 dB splitters that provide one-half the input signal energy or power to each of two output ports. In the preferred embodiment of the invention shown in FIG. 3a, one-half (½) the input signal energy is output at port 320, one-eighth (⅛^{th}) the input signal energy is output at each of ports 325 and 330, one-sixteenth (1/16^{th}) the input signal energy is output at each of ports 335 and 340 and one-thirty-second (1/32^{nd}) the input signal energy is output at each of ports 345, 350, 355 and 360. Accordingly, the amplitude distribution having a ramp-like characteristic or function that approximates the amplitude distribution of a network employing a sum and difference network is obtained.

FIG. 3b illustrates an amplitude distribution 370 of the preferred embodiment of the beam-forming network shown in FIG. 3a. In this case, the amplitude distribution follows a quasi-exponential ramp-like function, represented by line 375. In this case, the amplitude distribution exhibits a flattened lower end represented by the quantized or digitized values of amplitude at output ports 345, 350, 355, and 360.

FIG. 3c illustrates the “null-filled” far-field antenna pattern 385 generated by the preferred embodiment of the network 300 shown in FIG. 3a having an amplitude distribution shown in FIG. 3b compared to an ideal CSC² pattern 390.

As will be understood in the art, network 300 is fabricated such that the physical length of each branch between input port 110 and output ports 320-360 is substantially equal. In this manner, the signal path, and associated losses, are substantially the same. Furthermore, it is desirable that the electrical phase at each output port is also substantially the same.

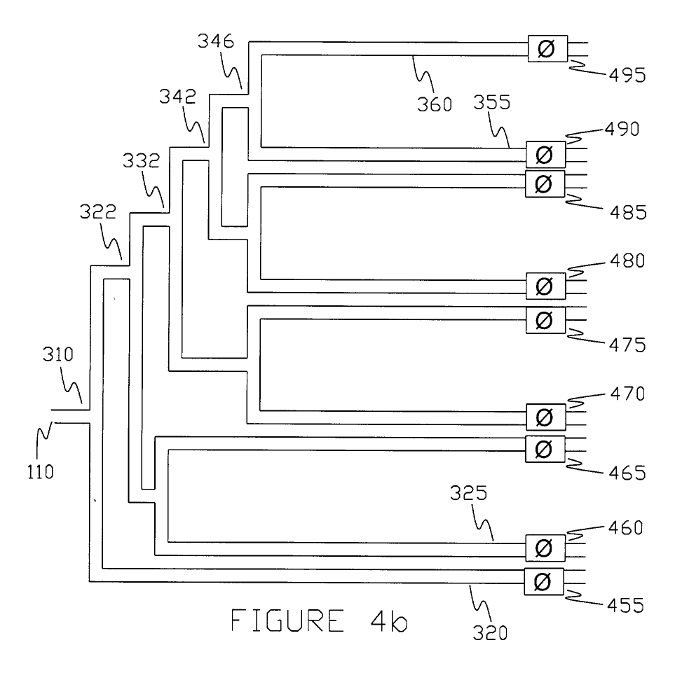

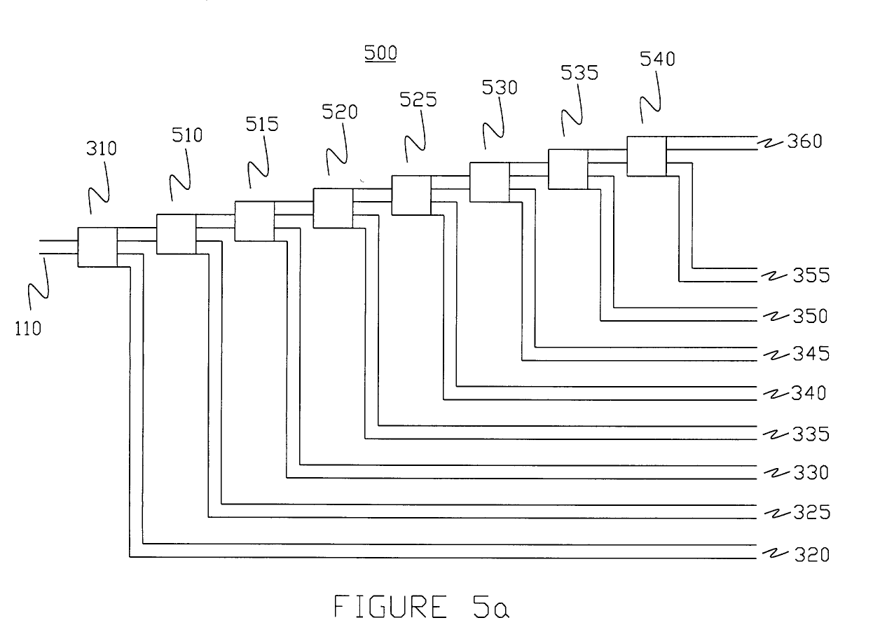

FIG. 4a illustrates a second aspect 400 of the present invention. In this aspect, phase compensators 410, 415, 420, 435, 430 and 435 are appropriately located in each waveguide branch of the beam-forming network shown in FIG. 1a. In this aspect, phase compensators 410, 415, 420, 435, 430 and 435 may be used to compensate for anomalies in the output electrical phase of each waveguide branch that may be introduced by imperfections or inaccuracies in the fabrication of network waveguide elements.

FIG. 4b illustrates a third aspect 450 of the present invention. In this aspect, phase compensators may be introduced at each output port. In this aspect, the phase compensators 455, 460, 465, 470, 475, 480, 485, 490, and 495 may adjust the phase to provide substantially equal electrical phase at each output port. Although not shown, it will be understood that phase compensators, 410-435, shown in FIG. 4a or FIG. 4b, may be mechanically or electrically adjusted to provide substantially the same electrical phase at each output.

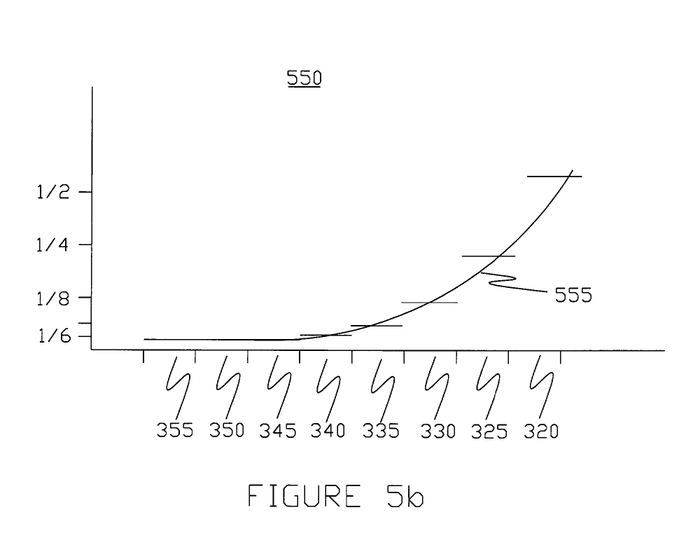

FIG. 5a illustrates another embodiment 500 of a 9-element beam-forming network in accordance with the principles of present invention. In this embodiment, a signal applied to input port 110 is divided by divider 310, such that a known portion of the applied signal energy or power is applied to output port 320 and the remainder is applied to divider 510. The signal applied to divider 510 is then divided such that the known portion of signal energy is applied to output 325 and the remainder is applied to divider 515. The remaining signal energy is then successive applied to dividers 515, 520, 525, 530, 535, and 540, such that progressively less amounts of the applied signal are output at ports 325, 330, 335, 340, 350, 355, and 360, respectively.

In another preferred embodiment of the invention, dividers 310, 510, 515, 520, 525, 530, and 535 are 3 db dividers or splitters that distribute one-half the signal energy or power applied to the input port to each of the two output ports. In this case, one-half (½) the input signal energy is output on port 320, one-quarter (¼) the input signal energy is output on port 325, one-eighth (⅛^{th}) the input signal energy is output on port 330, etc.

FIG. 5b illustrates an amplitude distribution of the preferred embodiment of the beam-forming network shown in FIG. 5a. In this case, the amplitude distribution is a monotonically increasing ramp function, represented by line 555, through the quantized or digitized amplitude values of each output port.

It will be appreciated that the waveguide length shown in FIG. 5a between the input port 110 and each output port is substantially equal. In this case, the signal loss in each waveguide is substantially the same. It is further desirable that the electrical phase at each output port be substantially the same.

In another aspect of the invention (not shown), and similar to that shown in FIG. 4a, phase compensators may be incorporated before each divider or coupler or splitter to compensate for phase alterations induced by imperfections or inaccuracies in the fabrication of the network branch elements. Each phase compensator may be individually adjusted, by electrical or mechanical means, to produce electrical phase values at the output ports that are substantially the same. In another aspect (not shown), phase compensators may be implemented at each output port.

In another aspect of the invention, a near field amplitude pattern generated by the network shown in either FIG. 3a or FIG. 5a may be a linear ramp function, i.e., triangular or sawtooth pattern. In this case, the amplitude value at each output port may be determined, for example, as:

$${A}_{i} = {A}_{1} - \frac{{A}_{1} - {A}_{l}}{n} * i ( i = 2 … n )$$

where Aᵢ is the amplitude at the i^{th} antenna port;

A₁ is the greatest amplitude output of the beam-forming network

Aₗ is the lowest output amplitude of the beam-forming network; and

n is the number of elements in the array.

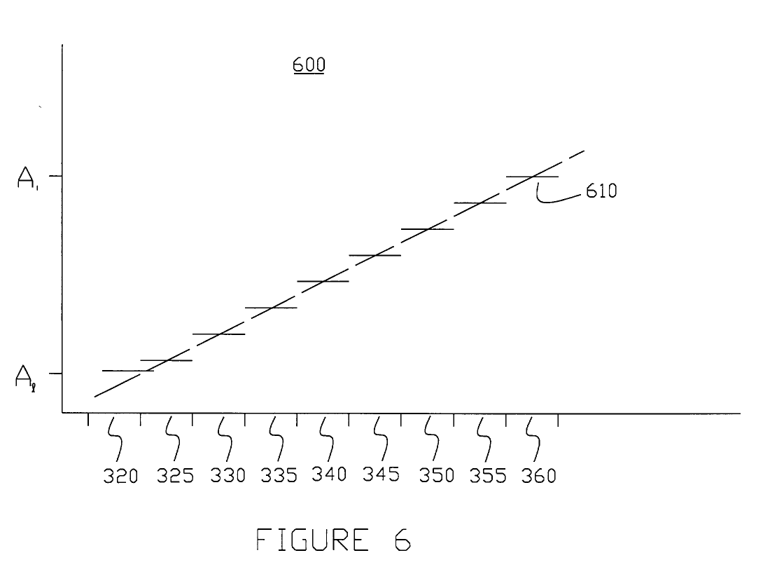

FIG. 6 illustrates an amplitude distribution 600 in accordance with the principles of the invention. In this case, the amplitude values at each output port 320-360 follows a ramp or triangular or sawtooth function represented by line 610.

As will be understood in the art, the amplitude values referred to herein may be represented as measures of signal power. Accordingly, calculations for determining desired output signal values may be performed using the well-known mathematics of logarithms.

Fundamental novel features of the present invention have has been shown, described, and pointed out as applied to preferred embodiments. It will be understood that various omissions and substitutions and changes in the apparatus described, in the form and details of the devices disclosed, and in their operation, may be made by those skilled in the art without departing from the spirit of the present invention. For example, although the present invention has been described with regard to antenna elevation patterns, it would be understood that horizontal or azimuth antenna patterns may similarly be developed in accordance with the principles of the invention.

It is also expressly intended that all combinations of those elements that perform substantially the same function in substantially the same way to achieve the same result are within the scope of the invention. Substitutions of elements from one described embodiment to another are also fully intended and contemplated.

I claim:

1. An antenna pattern beam-forming network comprising:
a signal input port;
a plurality of signal output ports arranged in an array; and
a plurality of couplers providing signal paths from said signal input port to said signal output ports through at least one of said couplers, wherein a distribution of amplitudes at said signal output ports of a signal energy applied at said input port substantially follows a ramp function.

2. The network as recited in claim 1, wherein said ramp function is substantially triangular.

3. The network as recited in claim 1, wherein said ramp function is substantially flat at a first end.

4. The network as recited in claim 1, wherein said ramp function is substantially curved.

5. The network as recited in claim 1, wherein each of said couplers has an input port and a first and second output port, wherein a known portion of a signal applied to said input port is output at said first output port and the remainder is output at said second output port.

6. The network as recited in claim 5, wherein said known portion is substantially one half said signal energy applied to said input port.

7. The network as recited in claim 1, wherein said couplers are 3 dB splitters.

8. The network as recited in claim 1, further comprising:
a phase compensator associated with each of said output ports.

9. The network as recited in claim 1, further comprising:
a phase compensator associated with selected ones of said couplers, said phase compensators operable to provide substantially equal phase among said output ports.

10. The network as recited in claim 8, further comprising:
means for adjusting said phase compensators.

11. The network as recited in claim 10, wherein said means are mechanical or electrical.

12. The network as recited in claim 9, further comprising:
means for adjusting said phase compensators.

13. The network as recited in claim 12, wherein said means are mechanical or electrical.

14. The network as recited in claim 1, wherein said ramp function is monotonically increasing.

15. The network as recited in claim 1, further comprising:
a second network comprising a plurality of couplers providing signal paths from said signal input port to said signal output ports through at least one of said couplers, wherein a distribution of amplitudes at said signal output ports of a signal energy applied at said input port is substantially symmetric.

16. A method of generating a null-filled antenna pattern approximating a double-sided cosecant squared pattern comprising the steps of:
coupling an input signal to a plurality of output ports through at least one coupler element wherein an amplitude distribution at said output ports of a signal energy applied at said input port follows substantially a ramp function.

17. The method as recited in claim 16, wherein said ramp function is substantially triangular.

18. The method as recited in claim 16, wherein said ramp function is substantially flat at a first end.

19. The method as recited in claim 16, wherein said ramp function is substantially curved.

20. The method as recited in claim 16, wherein each of said couplers has an input port and a first and second output port, wherein a known portion of a signal applied to said input port is output at said first output port and the remainder is output at said second output port.

21. The method as recited in claim 20, wherein said known portion is substantially one half said signal energy applied to said input port.

22. The method as recited in claim 16, wherein said couplers are 3 dB couplers or splitters.

23. The method as recited in claim 16, further comprising the step of:
adjusting the electrical phase at each of said output ports to achieve substantially the same electrical phase.

24. The method as recited in claim 16, further comprising the step of:
adjusting the electrical phase at selected one of said couplers to achieve substantially the same electrical phase at each of said outputs.

25. The method as recited in claim 23, wherein the step of adjusting comprises:
mechanical or electrical means.

26. The method as recited in claim 24, wherein the step of adjusting comprises:
mechanical or electrical means.

27. The method as recited in claim 16, further comprising the steps of:
coupling said input signal to a plurality of output ports through at least one coupler element, wherein a distribution of amplitudes at said output ports of a signal energy applied at said input port is substantially symmetric.
